(19) United States
(12) Patent Application Publication
(10) Pub. No.: US 2018/0158059 A1
(43) Pub. Date: Jun. 7, 2018

(54) Computerized Systems and Methods

(71) Applicant: Control Pay Intellectual Property Ltd., Ramat Gan (IL)

(72) Inventors: Ben Zion ADORAM, Ramat Gan (IL); Itamar Adoram, Givat Shmuel (IL)

(73) Assignee: Control Pay Intellectual Property Ltd., Ramat Gan (IL)

(21) Appl. No.: 15/832,811

(22) Filed: Dec. 6, 2017

Related U.S. Application Data
(60) Provisional application No. 62/430,368, filed on Dec. 6, 2016.

(51) Int. Cl. G06Q 20/40

(52) U.S. Cl. CPC G06Q 20/405

(57) ABSTRACT

This disclosure relates to the field of computerized processing of financial transactions. In particular, ways of verifying that the transferred funds are actually used for the specified purpose by the second party are described.

### CROSS-REFERENCE TO RELATED APPLICATIONS

Benefit is claimed to U.S. Provisional Patent Application No. 62/430,368, filed on Dec. 6, 2016, the contents of which are incorporated by referenced herein in their entirety.

### FIELD OF THE INVENTION

The various described embodiments are in the field of computerized processing of financial transactions.

### BACKGROUND OF THE INVENTION

It is generally accepted that budget planning can contribute to a reduction in expenditures. However, many people find it difficult to adhere to a budget.

In some cases a first party provides funds to a second party. Typically, the first party has little control over how the second party uses the funds once they are provided.

### SUMMARY OF THE INVENTION

A broad aspect of the invention relates to budgeting.

In some embodiments a first party provides funds to a second party for a specified purpose. Various exemplary embodiments of the invention relate to ways of verifying that the funds are actually used for the specified purpose by the second party. In other exemplary embodiments of the invention, a person makes a budget for them self and receives notices each time they make a purchase about how that purchase fits (or does not fit) their budget.

One aspect of some embodiments of the invention relates to comparison, by a computerized server, of an advance definition of permitted purchases for a specific user to a list of items presented at a point of sale (POS) for purchase by the user. According to various exemplary embodiments of the invention the permitted purchases are defined in terms of amount of money and/or time and/or store and/or location and/or specific item(s).

Another aspect of some embodiments of the invention relates to a comparison module in communication with both a POS interface receiving a list of items presented at a POS by a specific user and in communication with a server storing advance definition of permitted purchases for specific user. In some embodiments the comparison module screens proposed purchases by the specific user and either forwards them to a payment processing server for payment, or denies the proposed purchase. In some embodiments denial is of the entire proposed purchase. In other exemplary embodiments of the invention, denial is specific to items which do not match the definition.

Another aspect of some embodiments of the invention relates to a reporting module in communication with both a POS interface receiving a list of items presented at a POS by a specific user and in communication with a server storing a periodic budget for the specific user. In some embodiments the reporting module issues reports to a device associated with the specific user concerning use of their periodic budget. According to various exemplary embodiments of the invention reports are issued either in response to each purchase and/or with a fixed frequency (e.g. daily, weekly or monthly). According to various exemplary embodiments of the invention the reports include the percentage (and/or actual monetary amount spent and/or remaining) of one or more budget categories used in the present period and/or the amount of time remaining in the current budget period (e.g. in units of time and/or as a percentage).

Another aspect of some embodiments of the invention relates to submission of a proposed budget to a computerized server by a first user for review by a second user. In some embodiments the server issues a notice to the second user that a budget is awaiting review and/or issues a notice to the first user after the second user has completed the review.

It will be appreciated that the various aspects described above relate to solution of technical problems associated with control of how funds are actually used after they are allocated.

Alternatively or additionally, it will be appreciated that the various aspects described above relate to solution of technical problems related to adhering to a budget.

In some exemplary embodiments of the invention there is provided a method including: (a) receiving advance definition of a permitted purchase for a specific user at a server; (b) receiving a list of items presented at a point of sale (POS) for purchase by the specific user at the server across a network; and (c) comparing the advance definition to the list of items and allowing/denying at least a portion of the purchase based on results of the comparing. In some embodiments an entire purchase is denied if a single item in the list of items does not match the advance definition. Alternatively or additionally, in some embodiments a portion of the purchase conforming to the advance definition is allowed and a portion of the purchase not conforming to the advance definition is denied. Alternatively or additionally, in some embodiments the advance definition of the permitted purchase is defined in terms of at least one member selected from the group consisting of amount of money, time range, date range, store, location and specific item(s).

In some exemplary embodiments of the invention there is provided a computerized system including: (a) a definitions module receiving and storing permitted purchases for a plurality of specific users; (b) a points of sale (POS) interface receiving lists of items presented at a plurality of POS by specific users from the plurality of specific users; (c) a comparison module comparing the list of items presented at the POS by a single specific user to the permitted purchases for the single specific user making the purchase; and (d) a permission module that transmits transactions to a payment processor if the list of items presented matches the permitted purchases the single specific user making the purchase. In some embodiments the system includes dedicated hardware at the POS to transmit the lists and identity of a specific user to the POS interface. Alternatively or additionally, in some embodiments the POS interface receives the lists and identity of a specific user from standard credit card readers. Alternatively or additionally, in some embodiments the permission module denies an entire purchase if a single item in the list of items does not match the permitted purchases. Alternatively or additionally, in some embodiments the permission module allows a portion of the purchase conforming to the permitted purchases and denies a portion of the purchase not conforming to the permitted purchases. Alternatively or additionally, in some embodiments the permitted purchases are defined in terms of at least one member selected from the group consisting of amount of money, time range, date range, store, location and specific item(s).

In some exemplary embodiments of the invention there is provided a computerized system including: (a) a definitions module receiving and storing periodic budgets for a plurality of specific users; (b) a points of sale (POS) interface receiving lists of items and associated costs presented at a plurality of POS by specific users the plurality of specific users; and (c) a reporting module issuing reports to a device associated with one or more of the one or more specific user concerning use of the periodic budget by an individual specific user in response to each of the lists. In some embodiments the POS interface transmit the items and costs to the definitions module and the definitions module assigns each item and cost to a relevant budget category and computes remaining budget for that category. Alternatively or additionally, in some embodiments POS interface receives the lists and associated costs from a standard credit card reader. Alternatively or additionally, in some embodiments the reports are issued as an item selected from the group consisting of a text message and an e-mail message. Alternatively or additionally, in some embodiments the periodic budget is defined in terms of at least one member selected from the group consisting of amount of money, product category, store, and specific item(s). Alternatively or additionally, in some embodiments the reports include % of budget used for at least one budget category. Alternatively or additionally, in some embodiments wherein the reports include % of budget period remaining.

In some exemplary embodiments of the invention there is provided a method including: (a) receiving a proposed budget at a definitions module on a remote server from a first user; (b) issuing by a reporting module of the server a notice to a device associated with a second user to review the proposed budget; (c) further issuing by the reporting module of the server a notice to a device associated with the first user that the proposed budget has been reviewed by the second user. In some embodiments the method includes receiving one or more modifications to the proposed budget at the definitions module from the second user. Alternatively or additionally, in some embodiments the method includes receiving approval of the budget at the definitions module from the second user. Alternatively or additionally, in some embodiments the method includes receiving a refusal of the proposed budget at the definitions module from the second user.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is schematic system overview depicting an operational context of some embodiments of the invention;

FIG. 2 is a simplified flow diagram of a method according to some embodiments of the invention;

FIG. 3 is a schematic representation of a system according to some embodiments of the invention;

FIG. 4 is a schematic representation of a system according to some embodiments of the invention; and

FIG. 5 is a simplified flow diagram of a method according to some embodiments of the invention.

### DETAILED DESCRIPTION OF EMBODIMENTS

Embodiments of the invention relate to computerized methods and systems for financial oversight.

Specifically, some embodiments of the invention can be used to allow a first party to control how funds are disbursed by a second party and/or provide updates on budget status each time funds are disbursed.

The principles and operation of a method and/or system according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

Context System Overview

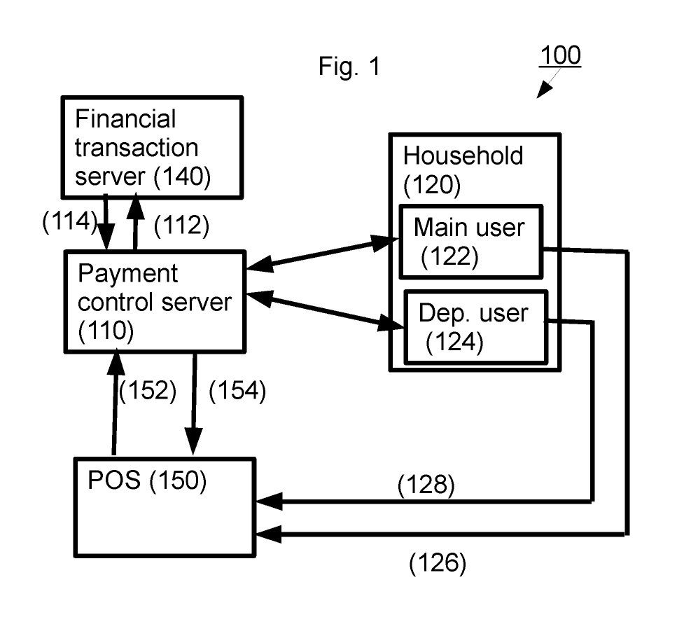

FIG. 1 is schematic system overview depicting an operational context, indicated generally as 100, of some embodiments of the invention.

In the depicted embodiment, the key elements are a payment control server 110 and a household 120. A single household is depicted for clarity although a much larger number will be present in actual practice. In other exemplary embodiments of the invention, household 120 is replaced by a business but the system operates in essentially the same manner and the results are similar.

In the depicted embodiment, household 120 has one or more main users 122 (a single main user is depicted for clarity) and one or more dependent users 124 (a single dependent user is depicted for clarity). Each of main users 122 communicates with server 110 to define budgets for themselves and/or dependent user(s) 124. Alternatively or additionally, each of main users 122 receives reports from server 110 concerning how budgeted funds for themselves and/or dependent user(s) 124 are disbursed.

Each of main users 122 and/or dependent users 124 communicates with payment control server 110 via a digital device such as a wearable device and/or smartphone and/or tablet and/or computer via any available channel of communication. Many embodiments of the invention employ the Internet and/or cellular data networks to transmit data between server 110 and/or users 122 and/or 124 in both directions.

In the depicted embodiment, each of main users 122 and dependent users 124 are provided with a purchasing card (126 and 128 respectively) which can be presented at a point of sale (POS) 150. In some embodiments the purchasing card 126 and/or 128 is a credit card or debit card. In other exemplary embodiments of the invention, purchasing card 126 and/or 128 is not issued by any financial institution but authorizes a transaction on a card account issued by a financial institution.

When card 126 or 128 is presented at POS 150 the POS transmits a purchase request 152 including a detailed listing of the items (and/or services) being purchased as well as the name and location of POS 150 to payment control server 110. Server 110 compares the details in request 152 to budgets established in advance by user 122 and/or 124. Based on that comparison server 110 responds 154 to POS 150 by allowing the transaction in its entirety, allowing a portion of the transaction while denying a portion of the transaction, or denying the transaction it its entirety. If response 154 allows part or all of the transaction, server 110 transmits a conventional financial transaction request 112 to financial transaction server 140 (e.g. a credit card clearinghouse). Server 140 responds 114 by either allowing or denying request 112 in its entirety.

Alternatively or additionally, in some embodiments server 110 issues a report on the transaction conducted with card 126 or 128 to main user 122 and/or dependent user 124.

Exemplary Purchase Authorization Method

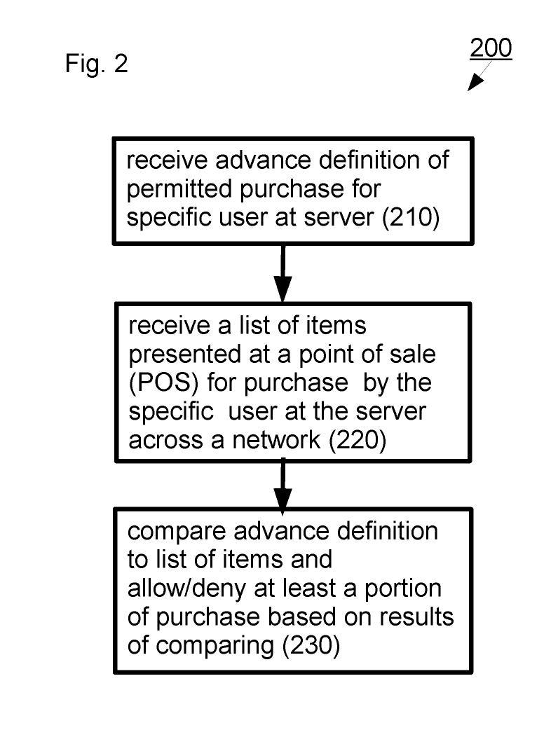

FIG. 2 is a simplified flow diagram of a method of purchase authorization, indicated generally as 200, according to some embodiments of the invention.

Depicted Exemplary method 200 includes, receiving 210 advance definition of a permitted purchase for a specific user at a server. In the depicted embodiment, method 200 also includes receiving 220 a list of items presented at a point of sale (POS) for purchase by the specific user at the server across a data network and comparing 230 the advance definition to the list of items and allowing/denying at least a portion of the purchase based on results of comparing 230.

In some embodiments of method 200 the entire purchase is denied at 230 if a single item in the list of items presented at the POS does not match the advance definition. In other exemplary embodiments of the invention, a portion of the purchase conforming to the advance definition is allowed at 230 and a portion of the purchase not conforming to the advance definition is denied.

According to various exemplary embodiments of the invention the advance definition at 210 of the permitted purchase is defined in terms of amount of money and/or time range and/or date range and/or store and/or location and/or specific item(s).

In the context of FIG. 1, method 200 allows a main user to allocate funds for one or more specific purposes on a card 128 belonging to dependent user 124 by providing advance definitions to payment control server 110. Note that depending on the degree of detail with which the purchase is defined in the advance definition, method 200 covers management of periodic budgets in some of its embodiments.

For example, main user 122 could allocate 48$ for entertainment on card 126 by authorizing 4 12$ transactions on Sep. 3, 10, 17 and 24, between 7 PM and 10 PM, with each transaction to be conducted at Mega Multiplex Cinema. Alternatively main user 122 could allocate 48$ for entertainment on card 126 by authorizing 48$ to be spent at Mega Multiplex Cinema during the month of September. Alternatively main user 122 could allocate 48$ for entertainment on card 126 by authorizing 48$ to be at any entertainment venue during the month of September. In some embodiments implementation of advance definitions with varying degrees of specificity allows a main user 122 to select and exercise a desired degree of control over how funds are disbursed through card 126 belonging to dependent user 124.

Exemplary Purchase Authorization System

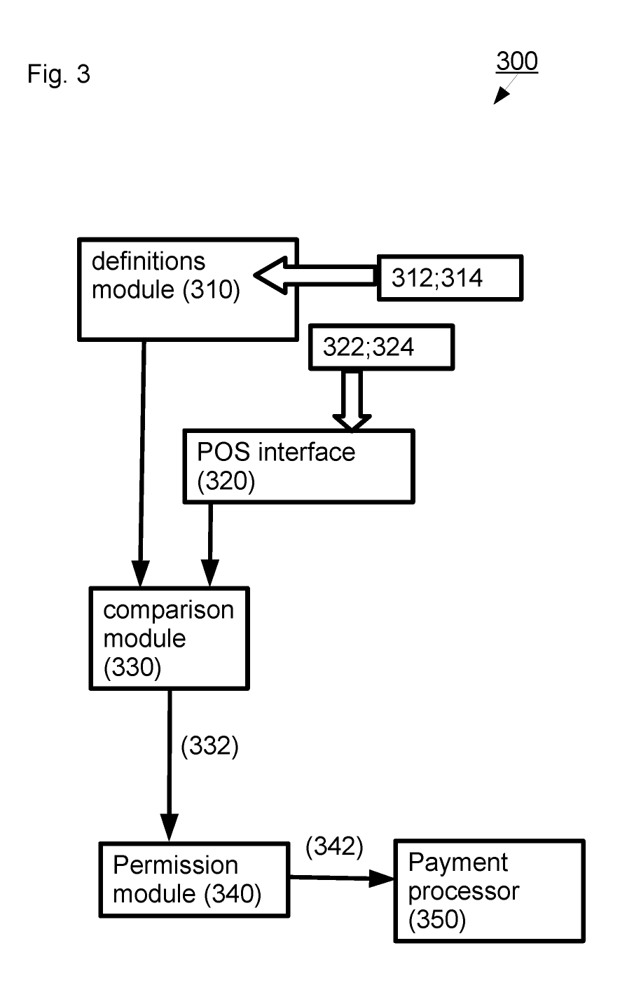

FIG. 3 is a schematic representation of a system for purchase authorization, indicated generally as 300, according to some embodiments of the invention.

Depicted exemplary computerized system 300 includes a definitions module 310 receiving and storing permitted purchases 312 for a plurality of specific users 314 and a points of sale (POS) interface 320 receiving lists 322 of items presented at a plurality of POS 324 by specific users from among the plurality of specific users 314.

In the depicted embodiment, a comparison module 330 compares a list of items 322 presented at a specific POS 324 to a specific permitted purchase 312 for a single specific user 314. In the depicted embodiment, comparison module transmits a comparison result 332 to a permission module 340 which decides whether to transmit a transaction 342 to a payment processor for payment approval. According to various exemplary embodiments of the invention system 300 is either independently operated or is integrated into existing financial transaction processing infrastructure.

In some embodiments of system 300 each POS 324 sending lists 322 to POS interface 320 is equipped with dedicated hardware to transmit lists 322 and identity of a specific user 314. In some embodiments of system 300, POS interface 320 receives said lists and identity of a specific user from standard credit card readers. Whether dedicated hardware or standard credit card readers are employed for data acquisition the POS ID is apparent from the card reading hardware.

In some embodiments permission module 340 denies the entire purchase if a single item in list 322 of items presented at the point of sale does not match the permitted purchases 312.

In some embodiments permission module 340 allows a portion of the purchase (list 322) conforming to permitted purchases 312 and denies a portion of purchase not conforming to permitted purchases 312.

According to various exemplary embodiments of the invention the permitted purchases are defined in terms of amount of money and/or time range and/or date range and/or store and/or location and/or specific item(s).

Exemplary Budget Monitoring System

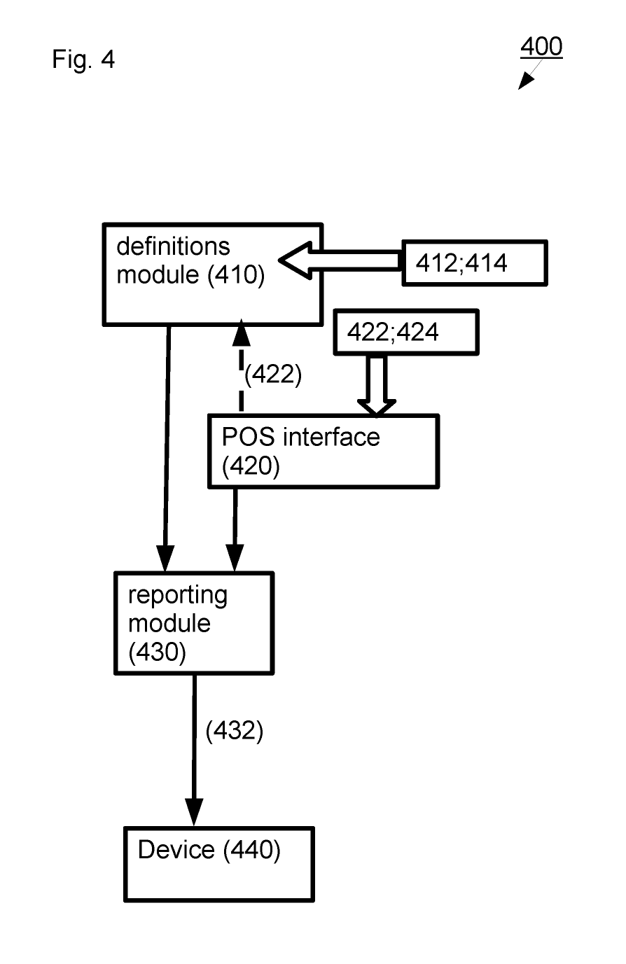

FIG. 4 is a schematic representation of a budget monitoring system, indicated generally as 400, according to some embodiments of the invention.

Depicted exemplary computerized system 400 includes a definitions module 410 receiving and storing periodic budgets 412 for a plurality of specific users 414 and a points of sale (POS) interface 420 receiving lists 422 of items and associated costs presented at a plurality of POS 424 by specific users from among the plurality of specific users. In the depicted embodiment, a reporting module 430 issues reports 432 to one or more devices 440 associated with one or more of the one or more specific users 414 concerning use of the periodic budget by an individual specific user 414 in response to each of lists 422.

In some embodiments, reporting module 430 receives data from definitions 30 module 410 and issues reports 432 based upon a comparison of data from POS interface 420 and definitions module 410. In some embodiments POS interface 420 transmits said items and costs (lists 422) to definitions module 410 which assigns each item and cost to a relevant budget category and computes remaining budget for that category. Alternatively or additionally, in some embodiments POS interface 420 receives lists 422 of items and associated costs from a standard credit card reader. In some exemplary embodiments of the invention reports 432 are issued as a text message and/or an e-mail message.

According to various exemplary embodiments of the invention the periodic budget is defined in terms of amount of money and/or product category and/or store and/or specific item(s). Exemplary product categories include, but are not limited to fuel, transportation, travel, lodging, food, restaurants, entertainment and clothing.

In some embodiments reports 432 include % of budget used for at least one budget category. Alternatively or additionally, in some embodiments reports 432 include % of budget period remaining.

Exemplary Budget Approval Method

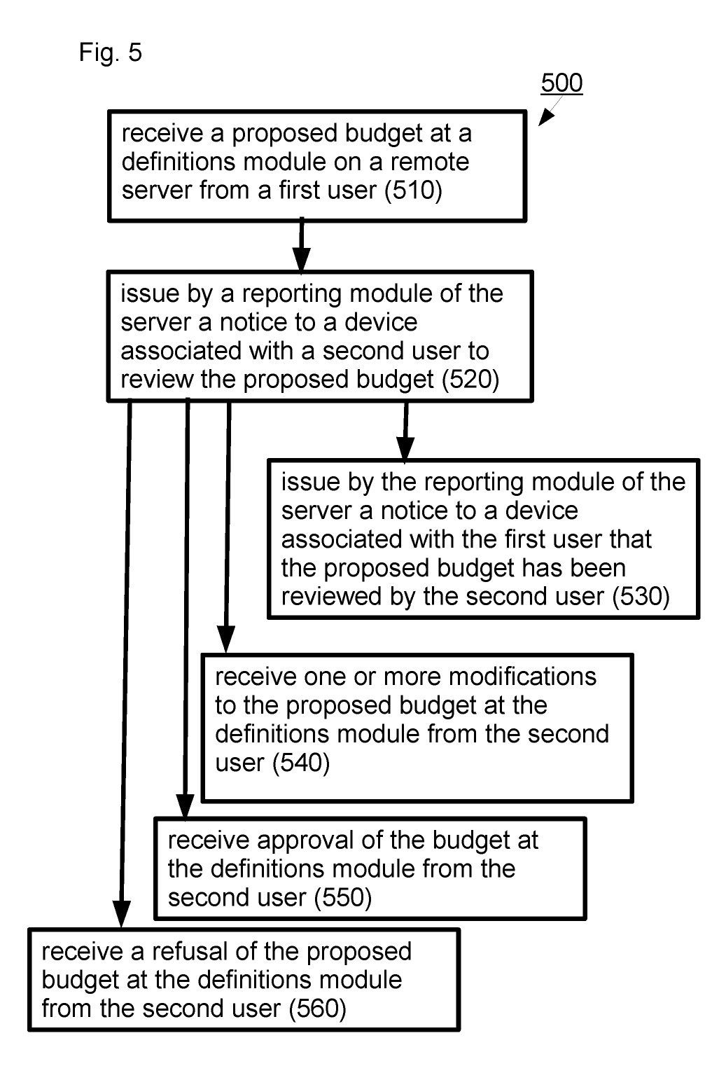

FIG. 5 is a simplified flow diagram of a method for budget approval, indicated generally as 500, according to some embodiments of the invention.

Depicted exemplary method 500 includes receiving 510 a proposed budget at a definitions module (e.g. 310 or 410 as described hereinabove in the context of FIGS. 3 and 4 respectively) on a remote server from a first user and issuing 520 by a reporting module of the server a notice to a device associated with a second user to review the proposed budget.

In the depicted embodiment, method 500 includes further issuing 530 by the reporting module of the server a notice to a device associated with the first user that the proposed budget has been reviewed by the second user.

In some embodiments method 500 includes receiving 540 one or more modifications to the proposed budget at the definitions module from the second user. In some embodiments method 500 includes receiving 550 approval of the budget at the definitions module from the second user. In some embodiments method 500 includes receiving 560 a refusal of the proposed budget at the definitions module from the second user.

It is expected that during the life of this patent many additional types of mobile communications devices will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Specifically, the invention has been described in the context of cards with the look and feel of credit cards but might also be used with online accounts (e.g. ITUNES or X-BOX).

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A method comprising:
(a) receiving advance definition of a permitted purchase for a specific user at a server;
(b) receiving a list of items presented at a point of sale (POS) for purchase by the specific user at the server across a network; and
(c) comparing the advance definition to the list of items and allowing/denying at least a portion of the purchase based on results of said comparing.

2. A method according to claim 1, wherein an entire purchase is denied if a single item in said list of items does not match said advance definition.

3. A method according to claim 1, wherein a portion of said purchase conforming to said advance definition is allowed and a portion of said purchase not conforming to said advance definition is denied.

4. A method according to claim 1, wherein said advance definition of said permitted purchase is defined in terms of at least one member selected from the group consisting of amount of money, time range, date range, store, location and specific item(s).

5. A computerized system comprising:
(a) a definitions module receiving and storing permitted purchases for a plurality of specific users;
(b) a points of sale (POS) interface receiving lists of items presented at a plurality of POS by specific users from said plurality of specific users;
(c) a comparison module comparing said list of items presented at said POS by a single specific user to said permitted purchases for the single specific user making the purchase; and
(d) a permission module that transmits transactions to a payment processor if said list of items presented matches said permitted purchases the single specific user making the purchase.

6. A system according to claim 5, comprising dedicated hardware at said POS to transmit said lists and identity of a specific user to said POS interface.

7. A system according to claim 5, wherein said POS interface receives said lists and identity of a specific user from standard credit card readers.

8. A system according to claim 5, wherein said permission module denies an entire purchase if a single item in said list of items does not match said permitted purchases.

9. A system according to claim 5, wherein said permission module allows a portion of said purchase conforming to said permitted purchases and denies a portion of said purchase not conforming to said permitted purchases.

10. A system according to claim 5, wherein said permitted purchases are defined in terms of at least one member selected from the group consisting of amount of money, time range, date range, store, location and specific item(s).

11. A computerized system comprising:
(a) a definitions module receiving and storing periodic budgets for a plurality of specific users;
(b) a points of sale (POS) interface receiving lists of items and associated costs presented at a plurality of POS by specific users said plurality of specific users; and
(c) a reporting module issuing reports to a device associated with one or more of the one or more specific user concerning use of the periodic budget by an individual specific user in response to each of said lists.

12. A system according to claim 11, wherein said POS interface transmit said items and costs to said definitions module and said definitions module assigns each item and cost to a relevant budget category and computes remaining budget for that category.

13. A system according to claim 11, wherein POS interface receives said lists and associated costs from a standard credit card reader.

14. A system according to claim 11, wherein said reports are issued as an item selected from the group consisting of a text message and an e-mail message.

15. A system according to claim 11, wherein said periodic budget is defined in terms of at least one member selected from the group consisting of amount of money, product category, store, and specific item(s).

16. A system according to claim 11, wherein said reports include % of budget used for at least one budget category.

17. A system according to claim 11, wherein said reports include % of budget period remaining.

18. A method comprising:
(a) receiving a proposed budget at a definitions module on a remote server from a first user;
(b) issuing by a reporting module of said server a notice to a device associated with a second user to review said proposed budget;
(c) further issuing by said reporting module of said server a notice to a device associated with said first user that said proposed budget has been reviewed by said second user.

19. A method according to claim 18, comprising receiving one or more modifications to said proposed budget at said definitions module from said second user.

20. A method according to claim 18, comprising receiving approval of said budget at said definitions module from said second user.

21. A method according to claim 18, comprising receiving a refusal of said proposed budget at said definitions module from said second user.
